(19) United States
(12) Patent Application Publication
(10) Pub. No.: US 2018/0264571 A1
(43) Pub. Date: Sep. 20, 2018

(54) Method and Apparatus for Attaching Threaded Fittings to Pipe

(71) Applicant: Russell Dwayne Woolverton, Rockdale, TX (US)

(72) Inventor: Russell Dwayne Woolverton, Rockdale, TX (US)

(21) Appl. No.: 15/920,211

(22) Filed: Mar. 13, 2018

Related U.S. Application Data
(60) Provisional application No. 62/470,962, filed on Mar. 14, 2017.

(51) Int. Cl. B23G 1/52; B25B 21/00

(52) U.S. Cl. CPC B23G 1/52; B25B 21/002

(57) ABSTRACT

A fitting threading adapter includes a pin shaped to engage at least one of an interior of a mandrel and locking dogs on a powered threading machine. The adapter includes a box end shaped to surround and apply rotation to a fitting threadedly engaged to a threaded end of another fitting or a pipe.

### CROSS REFERENCE TO RELATED APPLICATIONS

Priority is claimed from U.S. Provisional Application No. 62/470,962 filed on Mar. 14, 2017, which application is incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable

### BACKGROUND

This disclosure relates to the field of threaded couplings. More specifically, the disclosure relates to apparatus for attaching threaded devices to a threaded end of a pipe or conduit without the need to use hand tools such as a pipe wrench.

Threaded fittings such as, for example and without limitation, elbows, tees, valves and flanges may be threadedly coupled to a threaded end of a pipe or conduit. The threads on the end of the pipe or conduit may be formed by a power operated threading machine. An example of such a power operated threading machine is sold under model number 300-T2 by Ridgid, Inc. Suite 204-I, 850 Library Avenue, Newark, Del. 19711.

Once threads are formed at an end of a pipe or conduit, any of the above described fittings, among other thread-coupled devices, may be threadedly coupled to the end of the pipe or conduit. Such threaded coupling may include a human operator lifting the fitting to the end of the pipe or conduit, starting the threads and completing the threading by rotating the fitting and/or the pipe (or conduit) with a hand tool such as a pipe wrench.

Manual coupling of fittings or other devices to the threaded end of a pipe or conduit may be time consuming and labor intensive. It is desirable to have a device that can attach different types of thread-coupled fittings to the end of a pipe or conduit automatically and without the need for hand tools such as pipe wrenches.

### BRIEF DESCRIPTION OF THE DRAWINGS

FIG. 1 shows an example arrangement of a powered threading tool using a fitting adapter to couple a fitting to a pipe or conduit end.

FIG. 2 shows an example embodiment of a fitting adapter.

FIG. 3 shows another view of the example embodiment of a fitting adapter of FIG. 2.

FIG. 4 shows an end view of the example embodiment of a fitting adapter as shown in FIG. 2.

FIG. 5 shows an adapter mandrel locked in place in the powered threading tool of FIG. 1.

FIG. 6 shows the fitting adapter of FIG. 2 disposed in the adapter mandrel of FIG. 5.

### DETAILED DESCRIPTION

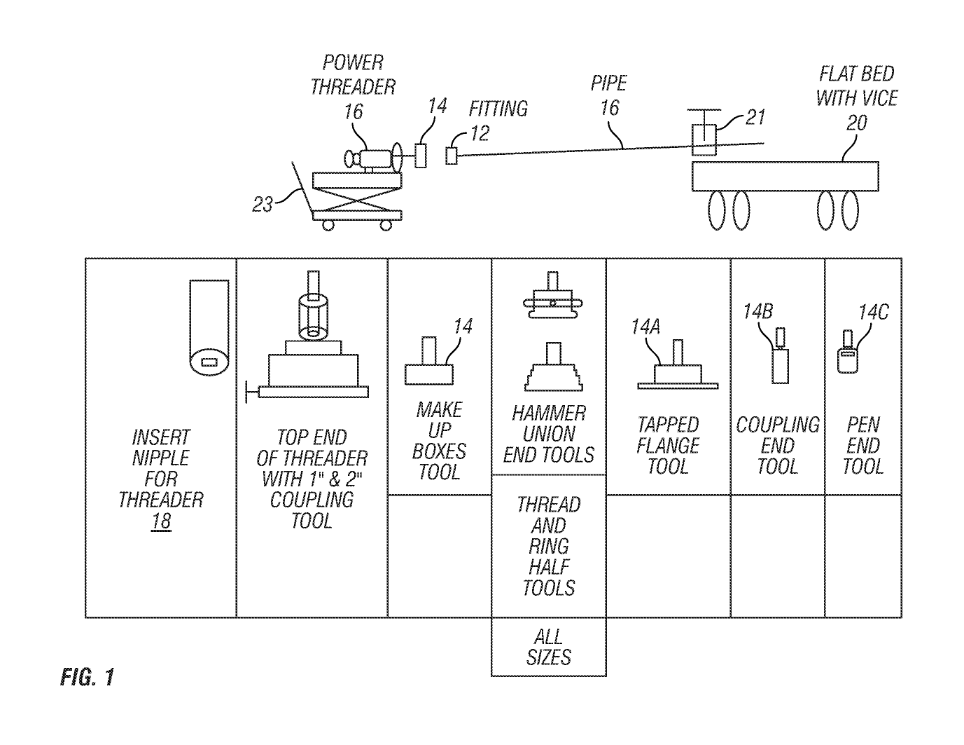

FIG. 1 shows an example arrangement of components to couple a fitting 12 or other thread coupled device to a threaded end of a pipe or conduit 10 (hereinafter “pipe” for convenience). The pipe 10 may be supported at a selected elevation on a cart or truck bed 20 and locked in place using a retainer 21 such as a vice, chain clamp or similar device coupled to the cart or truck bed 20. A power operated tool rotator 16 may be disposed on a movable cart having an adjustable height (elevation) table, such movable cart or table being shown generally at 23. A fitting threading adapter 14 is shown coupled to a rotating end of the power operated tool rotator 16. The power operated tool rotator 16 may be, for example and without limitation a power operated threading machine such as one sold under model designation 300-T2 by Ridgid, Inc. Suite 204-I, 850 Library Avenue, Newark, Del. 19711.

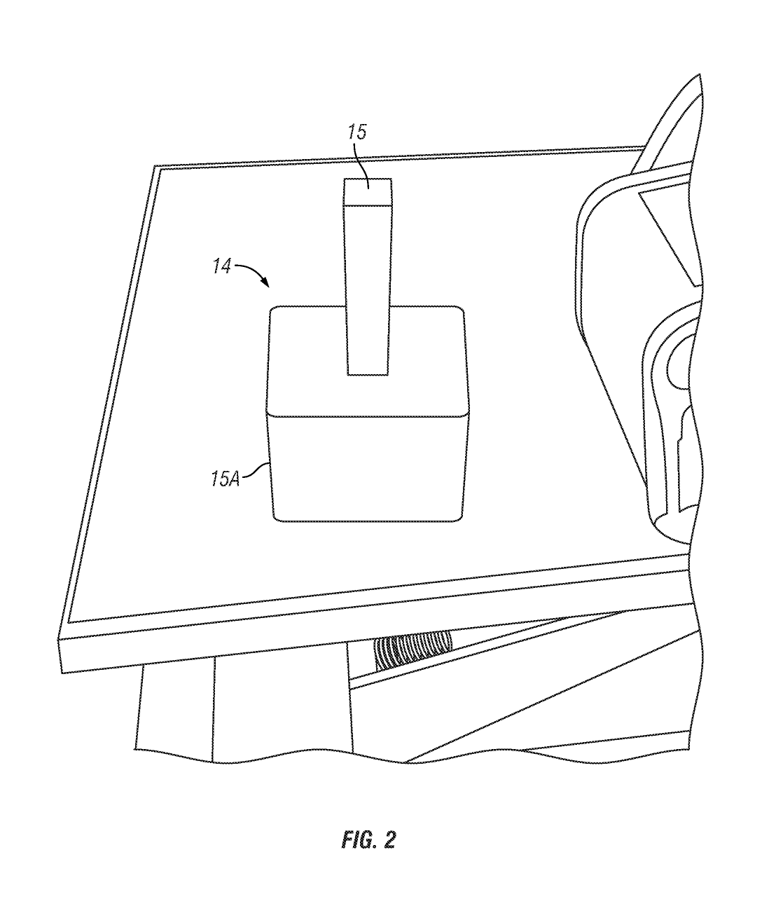

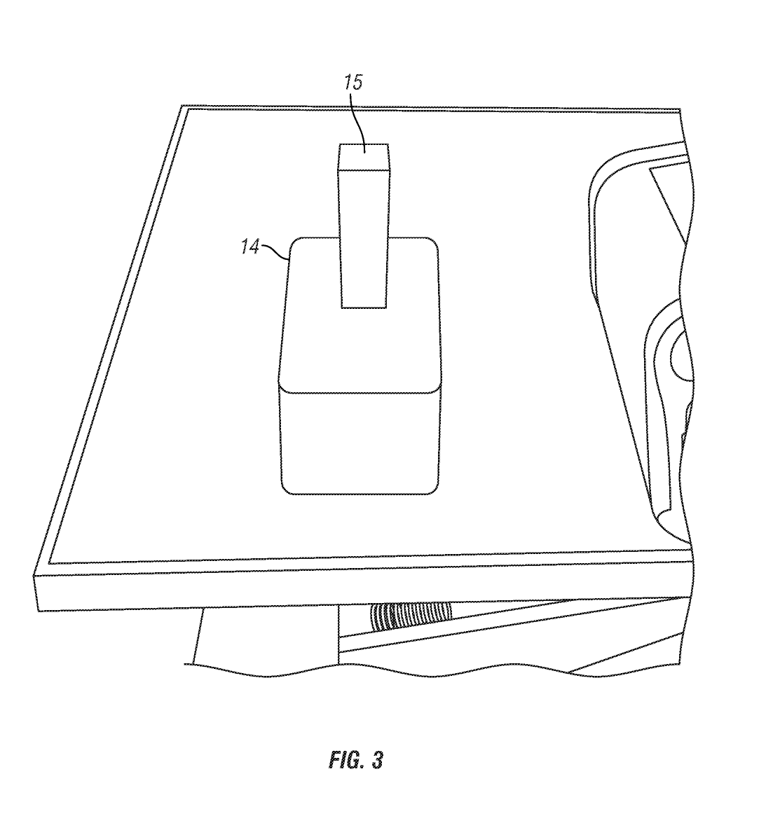

Shown separately at the bottom of FIG. 1 are an example of a mandrel 18, an example embodiment of the fitting threading adapter 14, another embodiment of the fitting threading adapter for use with flanges 14A, a coupling end tool 14B and a pin end tool 14C. Any of the foregoing fitting threading adapter embodiments may comprise a pin end (see FIG. 2 and FIG. 3) that may slide into a correspondingly shaped opening in the mandrel 18.

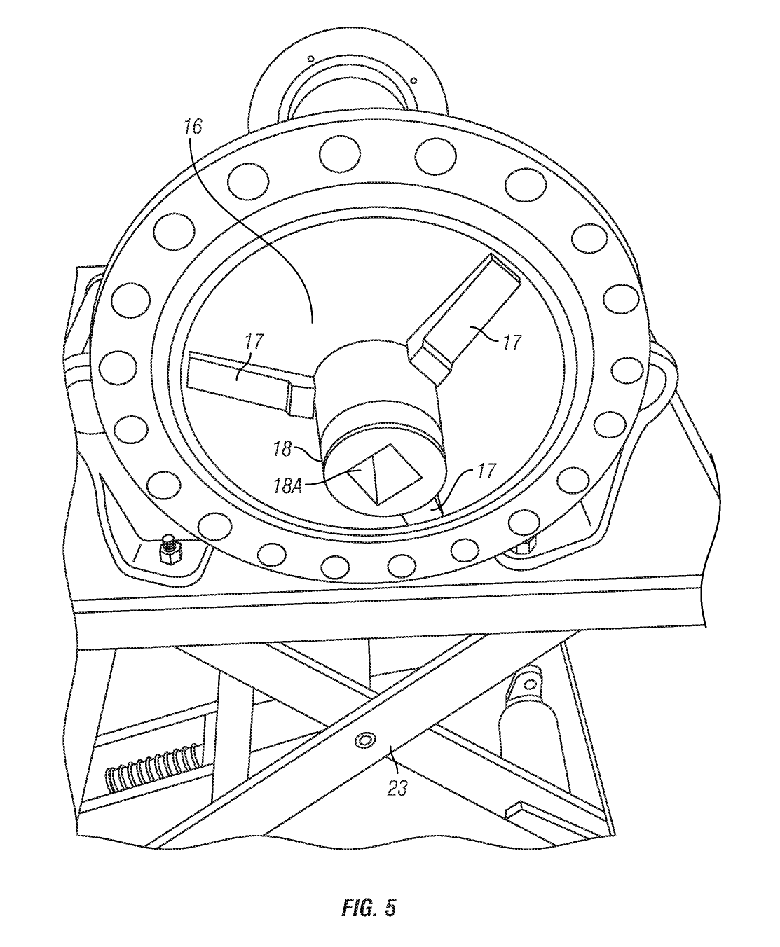

In the present embodiment, the power operated tool rotator may comprise locking dogs (see 17 in FIG. 5) ordinarily used to hold a pipe in a power operated threading machine (as explained above) in order to cut external threads on the pipe 10.

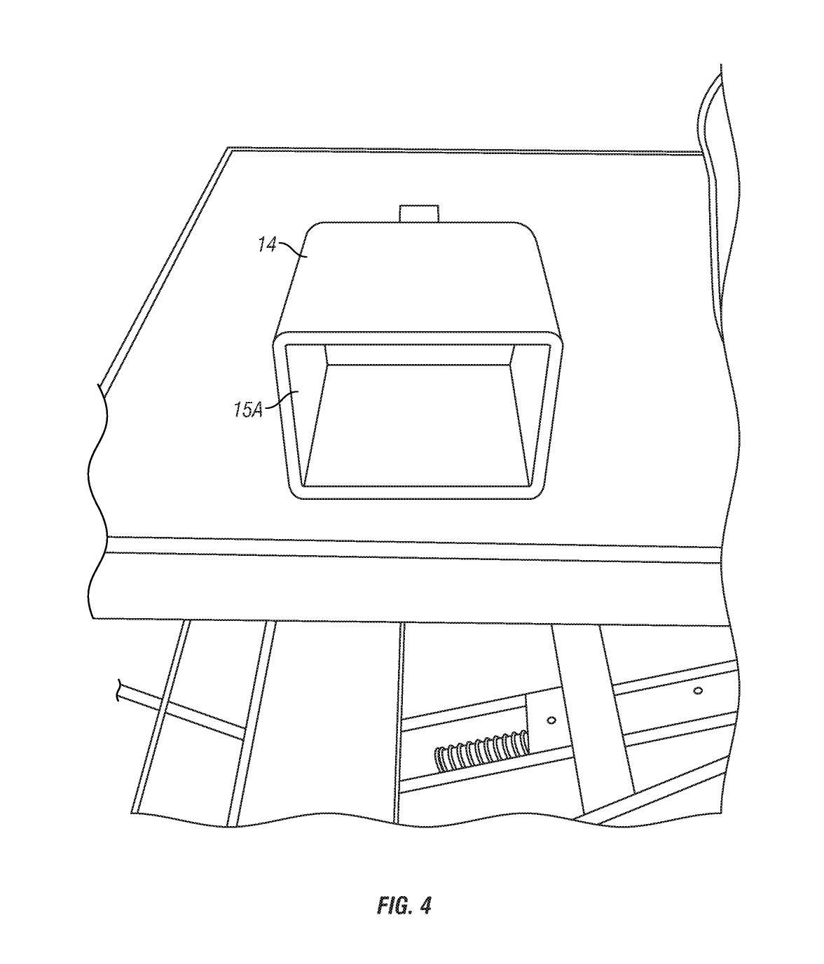

FIG. 2 shows an example embodiment of a fitting threading adapter 14 in more detail. The fitting threading adapter 14 may comprise a pin 15 shaped to engage a corresponding opening (see 18A in FIG. 5) in the mandrel (18 in FIG. 5). The pin 15 may be attached, such as by welding, to an adapter box 15A. The adapter box 15A may be shaped to enclose and rotatably engage a fitting (see 12 in FIG. 1) to be threaded onto the end of a pipe (10 in FIG. 1). FIG. 3 shows a view of the fitting threading adapter 14 rotated 90 degrees from the view shown in FIG. 2. FIG. 4 shows an end view of the fitting threading adapter 14 wherein the interior of the adapter box 15A may be observed. Although the adapter box 15A is shown as rectangular in FIGS. 2-4, it should be clearly understood that other embodiments of the adapter box 15A may have other shapes particularly suited to the type of fitting (12 in FIG. 1) being threaded onto the end of the pipe (10 in FIG. 1).

FIG. 5 shows the mandrel 18 held in place by the locking dogs 17 of the powered threading machine (power operated tool rotator 16). The present example embodiment using a mandrel 18 having an opening 18A of corresponding shape to the pin (15A in FIG. 2) on the fitting threading adapter (14 in FIG. 2) may provide the advantage of being able to change the adapter quickly and without the need to operate the locking dogs 17 on the power operated tool rotator 16.

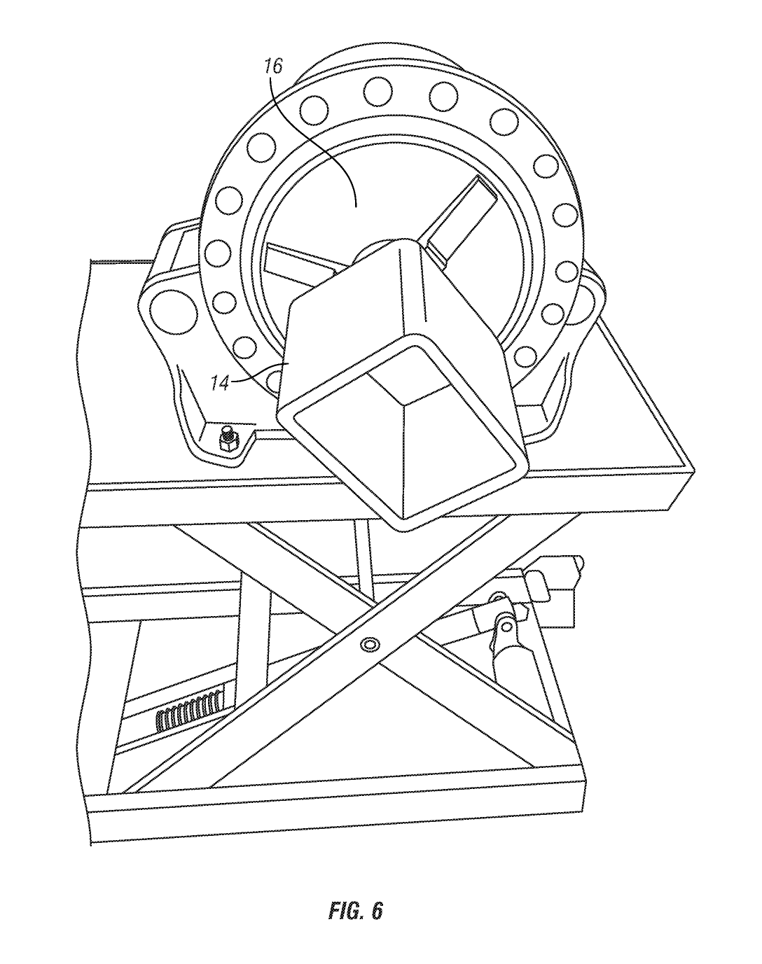

FIG. 6 shows the fitting threading adapter 14 disposed in the mandrel (not visible in FIG. 6), wherein the mandrel is locked in the power operated tool rotator 16.

Using the power operated tool rotator 16 with a fitting threading adapter may include the following with reference to FIG. 1. A pipe 10 having a threaded end may be secured in a retainer 21 or similar device affixed to a cart, flatbed or any similar device 20. A fitting 12 may be manually affixed to the end of the pipe 10 so as to start the threads. The powered threading machine 16 may be lifted on its table 23 so that the center of rotation of the powered threading machine 16 is approximately coaxial with the pipe 10. The mandrel (18 in FIG. 5) may be locked into place in the power operated tool rotator (power operated threading machine) 16 and a suitable fitting threading adapter 14 may be inserted into the mandrel 18 as explained with reference to FIG. 5 and FIG. 6. The cart 23 may then be moved so that box (15A in FIG. 2) of the fitting threading adapter 14 covers the fitting 12. The power operated tool rotator (power operated threading machine) 16 may then be operated to rotate the fitting threading adapter 14 and thus the fitting 12. Rotating the fitting 12 may thus further engage internal threads on the fitting 12 with external threads on the pipe 10. When the threads are determined to be sufficiently engaged, the power operated tool rotator (power operated threading machine) 16 may be stopped. The foregoing procedure may be repeated for any number of pipes and fittings. In one example embodiment, the threads on the fitting 12 and the pipe 10 may be self-sealing threads such as tapered pipe threads (NPT), although the type of threads is not intended to limit the scope of the present disclosure.

Other embodiments of the pin 15 on the fitting threading adapter 14 may be directly engaged with the locking dogs 17; using the mandrel 18 is not intended to limit the scope of the present disclosure.

A fitting threading adapter used with a powered threading machine as described herein may substantially reduce the time and effort required to assembly fittings to pipe and/or to other devices.

Although only a few examples have been described in detail above, those skilled in the art will readily appreciate that many modifications are possible in the examples.

Accordingly, all such modifications are intended to be included within the scope of this disclosure as defined in the following claims.

What is claimed is:

1. A power operated thread engaging apparatus, comprising:
a fitting threading adapter comprising,
a pin shaped to engage at least one of an interior of a mandrel and locking dogs on a power operated tool rotator and
a box end shaped to surround and apply rotation to a fitting threadedly engaged to a threaded end of another fitting or a pipe; and
a power operated tool rotator engaged with the pin to rotate the fitting threading adapter.

2. The apparatus of claim 1 wherein the pin is shaped to engage a correspondingly shaped opening in a mandrel, the mandrel shaped externally to engage the locking dogs.

3. The apparatus of claim 1 wherein the box end is rectangularly shaped.

4. A method for threading a fitting onto a threaded end of another fitting or a pipe, comprising:
manually starting threads in the fitting onto the threads of the other fitting or pipe;
engaging a fitting threading adapter to a rotating end of a power operated tool rotator;
moving the power operated tool rotator to be approximately coaxial with the fitting and such that a box on the adapter surrounds the fitting; and
operating the power operated tool rotator such that the fitting is threaded onto the other fitting or pipe.

5. The method of claim 4 wherein the power operated tool rotator comprises a power operated threading machine.

6. The method of claim 5 wherein engaging the fitting threading adapter to the rotating end comprises engaging locking dogs.

7. The method of claim 6 wherein the locking dogs are engageable with and to retain a pipe in the power operated threading machine.
